(19) United States
(12) Patent Application Publication
(10) Pub. No.: US 2019/0316259 A1
(43) Pub. Date: Oct. 17, 2019

(54) Method for Producing a Glass Coating on a Substrate

(71) Applicant: SEPIES GmbH, Vaterstetten (DE)

(72) Inventors: Siegfried Piesslinger-Schweiger, Vaterstetten (DE); Olaf Boehme, Erding (DE)

(21) Appl. No.: 16/343,122

(22) PCT Filed: Oct. 17, 2017
(86) PCT No.: PCT/EP2017/076449

§ 371 Date: Apr. 18, 2019

(30) Foreign Application Priority Data
Oct. 19, 2016 (EP) 16 002 244.8
May 11, 2017 (EP) 17 170 573.4

(51) Int. Cl. C23C 18/12; C03C 1/00

(52) U.S. Cl. CPC C23C 18/1254; C23C 18/1208; C03C 1/008; C23C 18/1241; C23C 18/1245; C23C 18/1233

(57) ABSTRACT

The invention relates to a method for producing a glass coating on a substrate, comprising the following steps: applying a liquid sol to at least one surface of the substrate, allowing the sol to react to form a gel, and briefly treating the gel on the at least one surface outside a furnace in the presence of water vapour at a temperature of at least 700° C. The method according to the invention makes the coated surface dirt-repellent, electrically insulating, non-combustible, easy to clean and resistant to ageing, corrosion and chemicals. A particular advantage of the method according to the invention is that it can be carried out outside a furnace and nevertheless makes glass coatings possible.

The invention relates to a process for producing coating or sealing surfaces of articles made of different materials such as metal, ceramic, concrete, stone or wood with an impervious, firmly adhering, noncombustible, thermally stable and hard layer of glass. The surfaces obtained in accordance with the invention are soil-repellent, electrically insulating, noncombustible, easily cleanable and stable to aging, corrosion and chemicals. The glass layers may be either transparent or configured in any desired color and color intensity. The process is employable anywhere, even on site and on fixedly installed objects. The use is largely independent of the shape and size of the components to be sealed.

### BACKGROUND OF THE INVENTION

### Enameling

In order to provide metal surfaces, usually on steel or copper alloys, with inorganic protective glass layers that are stable to high temperatures and to chemicals, the technique of enameling is traditionally employed. For this purpose, metal surfaces, after a suitable pretreatment to achieve a firmly adhering coating, are coated with a frit consisting essentially of finely ground glass, chemicals, color pigments and binders. Subsequently, the workpieces coated with the frit are introduced into an oven and heated above the melting point of the glass. This forms a firmly adhering, protective coating of glass, the enamel, on the metal surfaces.

Enameling generally requires temperatures in the range from 700° C. to 1000° C. over a prolonged period of time. This requires materials as a basis that can withstand the temperatures over a prolonged period without changing shape and properties.

Enamel layers are hard and brittle. They tend to flake off in the event of impacts and deformation. Damaged enamel layers can only be repaired with great difficulty, if at all.

### Glazing

In order to make surfaces of ceramic or porcelain watertight, easy to clean and attractive, they are traditionally glazed. For this purpose, similarly to the enameling process, the surfaces to be glazed are covered with a frit composed of finely ground glass and mineral pigments. Subsequently, the parts are heated in an oven up to above the melting point of the glass. The result is a smooth, hard, water-impervious, usually colored surface which is resistant to chemicals and high temperatures. Damaged glazes can be repaired only with great difficulty, if at all.

### Sol-Gel Coatings

Sol-gel coatings are usually applied to metal surfaces. They have a glass-ceramic structure with considerable organic constituents.

Sol-gel coatings generally consist of two reaction components that are mixed with one is another in a fixed ratio shortly prior to processing. This mixture is finally admixed with a diluent, usually an alcohol. The dilution adjusts the concentration of the reaction mixture and the viscosity of the final mixture. The sol-gel is a silica sol based on hydrolyzable siloxanes that are dissolved in solvents, and the silica sol may additionally contain one or more further sol-forming elements, preferably from the group consisting of Al, Ti, Zr, Mg, Ca and Zn, where these elements replace the silicon atoms in the colloidal structures. Preferred sol-gel coatings/sol-gel lacquers and the use thereof are described in EP 2145980, to which particular reference is made here.

The starting compounds for formation of the sols and ultimately of the sol-gel lacquer are hydrolyzable siloxanes of the formula SiR₄ where the 4 radicals comprise 2-4 hydrolyzable OR′ radicals and 0-2 nonhydrolyzable R″ radicals.

The hydrolyzable OR′ radicals are hydroxyl, alkoxy and/or cycloalkoxy radicals. Suitable examples of these preferably include ethoxy, n-propoxy and isopropoxy radicals. The hydrolyzable OR′ radicals may be the same or different.

The nonhydrolyzable R″ radicals, if present, are alkyl and/or cycloalkyl radicals. Suitable examples preferably include methyl, ethyl, n-propyl and isopropyl radicals. The nonhydrolyzable R″ radicals may likewise be the same or different.

The R′ or R′ radicals in the broadest sense should be regarded as aliphatic hydrocarbons (linear, branched or cyclic, with 1 to 8 carbon atoms).

In the sol, the starting compounds have been partly hydrolyzed to the corresponding hydroxyl compounds (for instance orthosilicic acid, trihydroxyalkylsilane, etc.), which can be promoted by the addition of a catalyst, for instance of acid. Owing to the high tendency to condensation of these hydroxyl compounds, these can then condense with elimination of water to give smaller siloxane networks. The sol already includes colloidal particles containing siloxane bonds. Siloxane bonds are bonds of the ≡Si—O—Si≡ form where “≡” symbolizes any three independent bonds to other elements, especially to OH, OR′ and R″, with formation of a three-dimensional crosslinked structure in the colloidal particles.

The sol-gel lacquer can be applied in any manner, for instance by spray application, dipping, flow-coating or painting. However, it is preferably applied by spraying, which enables exact control of the amount applied per unit area.

The amount can be adjusted as required. In practice, sol-gel layers have a thickness of about 0.5 μm to 8.0 μm, preferably a thickness of 1.0 μm to 5.0 μm, in order firstly to ensure continuous coverage of the surface and secondly to still produce a stable layer without cracks and detachment.

Thereafter, the sol applied is left to react to form a gel. This reaction transforms the liquid sol to a solid gel layer in which the colloidal particles of the sol crosslink with one another and with as yet unhydrolyzed and uncondensed starting compounds by further hydrolysis and condensation. This can take place, for example, as a result of evaporation of the alcoholic solvent in the course of drying.

Typically, a sol-gel lacquer is applied to the surfaces to be coated by spraying, dipping or painting. Thereafter, the lacquer is dried. In the course of this, the diluent or solvent evaporates and a solid gel composed of a network of silicon dioxide and OH groups forms.

Subsequently, the surfaces are baked in an oven at temperatures between 200° C. and 400° C. for a duration of 20 to 60 minutes, and the components are also heated to the same temperature. The layers formed already have a glass-ceramic structure consisting essentially of a network of silicon dioxide and organic functional groups. These groups determine the typical properties of sol-gel layers thus obtained, for example hydrophobicity. Such layers are smooth and often porous. Hardness is determined to a distinct degree by the baking temperature and, expressed as scratch hardness, is regularly within a range from 400 g to 800 g.

Sol-gel layers of this kind can actually be applied only to those metallic workpieces that are not damaged at all at the customary high firing temperatures. This is because, after the application of the sol-gel layers, it is barely possible to repair any damaged sites. In such a case, it would be necessary to undertake, for example, complete delamination and then to recoat the component.

### DETAILED DESCRIPTION OF THE INVENTION

The aim of the invention is a process that enables application of a pore-free, impervious and firmly adhering glass layer to the surfaces of articles made of different materials, which reliably protects the surfaces from environmental influences and which can be applied in a simple and reliable manner. As an essential difference from enameling, glazing or sol-gel methods, the process of the invention is not to exert any significant temperature effects on the base material. The application of the coating should not entail any complex devices such as baking ovens or environmentally polluting chemicals and should be employable independently on site at any time.

The process of the invention proceeds from sol-gel methodology.

In the first stage, a sol-gel lacquer is applied to the surfaces to be sealed.

Sol-gel coatings generally consist of two reaction components that are mixed with one another in a fixed ratio shortly prior to processing. This mixture is admixed with, as a third component, a diluent, usually an alcohol, in order to adjust the concentration of the reaction mixture and its viscosity. The starting compounds for formation of the sols and ultimately the sol-gel lacquer are hydrolyzable silanes of the formula SiR₄ where the 4 R radicals comprise 2-4 hydrolyzable radicals (OR′) and 0-2 nonhydrolyzable radicals (R″).

The hydrolyzable OR′ radicals are hydroxyl, alkoxy and/or cycloalkoxy radicals. The nonhydrolyzable R″ radicals, if present, are alkyl and/or cycloalkyl radicals.

The starting compounds of the sols may consist of a single kind of siloxane or of mixtures of multiple siloxanes. For the process of the invention, preference is given to using mixtures that also contain tetramethoxysilane and trimethoxymethylsilane. Other mixtures are also possible and suitable.

In the sol, the starting compounds have been partly hydrolyzed to the corresponding hydroxyl compounds, which can be promoted by the addition of a catalyst in the form of acid. As a result of the high tendency of these hydroxyl compounds to condensation, they can then condense with elimination of water to form smaller siloxane networks. The sol already includes colloidal particles containing siloxane bonds. Siloxane bonds are bonds of the ≡Si—O—Si≡ form where “≡” symbolizes any three independent bonds to other elements, especially to OH, OR′ and R″, with formation of a three-dimensional crosslinked structure in the colloidal particles.

The sol-gel lacquer can be applied in any manner, for instance by spray application, dipping, flow-coating or painting. The viscosity of the sol-gel lacquer can be adjusted by the person skilled in the art by adding solvents to the requirements of the material to be coated.

After the application, the sol applied is left to react to form a gel. This reaction transforms the liquid salt of a solid gel layer in which the colloidal particles of the sol crosslink with one another and with as yet unhydrolyzed and uncondensed starting compounds by further hydrolysis and condensation. This takes place, for example, as a result of evaporation of the solvent in the course of drying.

According to the prior art, the dried sol-gel layers, after drying, would be baked in an oven at temperatures of 150° C. to 400° C. for a duration of 20 to 60 minutes in order to produce a glass-ceramic structure.

In a departure from this, the process of the invention takes another route: The invention is based on the surprising finding that it is possible to convert sol-gel layers, without baking, directly to pure glass layers that do not contain any crystalline structure organic radicals. These glass layers are homogeneous without structures, free of pores and very hard. They are homogeneously bonded to the substrate and do not become detached.

For this purpose, the process of the invention, in the dried sol-gel lacquer, replaces the siloxane bonds to the organic R′ and R″ radicals with O—Si—O bonds in order to produce a homogeneous inorganic three-dimensional network of SiO₂. This is nothing more than glass.

Surprisingly, a suitable process for achieving the aim was found to be a treatment of the sol-gel lacquer with superheated steam at temperatures above 700° C. The properties of water or steam in this temperature range are distinctly different than the properties of water at standard temperature.

The present invention originates from the finding that, for formation of a homogeneous and stable glass layer (amorphous glass), proceeding from sol-gel lacquers, a brief (from about 2 to 4 seconds) exposure or treatment of a sol-gel layer applied to a substrate with a water-containing atmosphere at a temperature above 700° C. is sufficient. The applicant has additionally found that a purely thermal treatment of such surfaces does not lead to the desired stable glass surfaces. This difference can very probably be attributed to the fact that the water, in the temperature range specified, reacts with the organic radicals in the siloxane structures, and first of all converts the organic radicals to alcoholic intermediates that then react later on to give carbon dioxide and water. The remaining structures then crosslink in the presence of water to give a homogeneous network of (SiO₂)ₙ. In the case of a purely thermal treatment of the sol-gel lacquers, it is probably also possible to achieve elimination and breakdown of the organic radicals from the sol-gel layer. However, it was observed that, in the case of such a procedure, there is no homogeneous formation of an (SiO₂)ₙ network, but instead formation of crystalline regions that can be seen even by the naked eye. The end result, and especially in the event of further thermal stress on the surface, is cracks extending as far as breakdown of the layer.

In the coatings of the invention, it was additionally found that, surprisingly, not only did a homogeneous, amorphous network of a glass form, but that the glass coatings obtained can also be subjected to a further temperature exposure without any problem. This fact constitutes a particular simplification of the process since a brief treatment with the superheated steam is of course necessary first of all, but does not constitute any further restriction at all in the boundary conditions of the process. In other words, the process of the invention can also be implemented by relatively untrained workers since, given exceedance of the conditions required for the forming of the amorphous glass layer, in terms of temperature and the presence of water, no further restrictions have to be fundamentally observed. However, restrictions do of course arise with regard to the treatment time of the layers if the substrates beneath the glass layer are to have a certain thermal sensitivity.

In this connection, thermal sensitivity is understood to mean that the substrate can melt and/or react, for example, at a certain temperature.

A particular advantage of the present process is especially considered to be that the time until a stable glass layer is obtained is relatively short, and so it is possible in accordance with the invention to coat even those substrates that would normally be subject to a chemical and/or physical transformation in the event of prolonged exposure to the temperatures used in accordance with the invention with a glass layer.

The action of superheated water attacks the organic radicals in the siloxane bonds and converts them to CH₃—OH (methanol). In the next stage, CH₃—OH can be oxidized to CO₂+H₂O (carbon dioxide and water vapor), which escape as gas.

In the treatment of the sol-gel lacquer in the presence of water (for example superheated steam) at temperatures above 700° C., the above-described reactions proceed spontaneously in seconds. It is not necessary or desirable here to heat the sol-gel lacquer itself to a correspondingly high level. As a result of the treatment, the original sol-gel layer gives rise to a homogeneous, three-dimensional network of SiO₂, which is nothing more than glass, comparable to enamel. This network withstands thermal stresses up to about 1100° C. and chemical attack for a prolonged period.

A steam-containing atmosphere having temperatures exceeding 700° C. which is usable for the performance of the process of the invention can be found, for example, in the offgas stream from gas flames that are operated with an excess of oxygen. The combustion of the gas gives rise to water vapor and carbon dioxide. The temperatures required for the process of the invention are easy to establish via the distance of the visible flame zone from the surfaces to be sealed.

For performance of the sealing of the invention, the surfaces to be sealed are first cleaned to free them of contaminants such as grease, paint, corrosion products and loose particles.

Subsequently, the sol-gel lacquer is applied by spraying, painting, dipping or flow-coating. In the case of strongly absorptive substrates, the application can be effected in multiple steps with intermediate drying under air until a continuous lacquer layer is achieved. As soon as the solvent evaporates and the layer is dry, as the next step, the sol-gel layer is converted to glass.

is The conversion of the sol-gel layers to glass is accomplished by treating the surfaces with superheated steam in the temperature range from 800° C. to 1100° C. This can be effected by exposing the surfaces to a gas flame which is operated with excess oxygen.

The flame treatment of the coated surfaces by means of a gas flame operated with oxygen in excess is a reliable, simple and economically viable method of producing the seal of the invention.

The treatment times for the flame exposure, according to a temperature of the flame, distance of the flame from the surface and thickness of the sol-gel layer, are in the range from 10 seconds to about 60 seconds. The flame exposure of the surfaces can also be effected in multiple separate steps for shorter periods of time in order essentially to heat the sol-gel layer only and to avoid excessive heating of the base material. The flame exposure can be effected, for example, in multiple relatively short component steps of, for example, 10 seconds to 15 seconds separated by cooling times of several minutes.

The process of the invention enables sealing of virtually any solid material by means of a glass layer produced in accordance with the invention.

The invention thus also provides those composite materials where a layer which is thermally sensitive under some circumstances (as described above) is coated with a permanent glass layer. The invention specifically enables composite materials with a glass layer in which the substrate provided beneath the glass layer is regarded as being thermally sensitive. In this connection, “thermally sensitive” means quite generally that the substrate would be subject to a chemical and/or physical transformation, for example, at a temperature above 100° C.—or else above 300° C., 400° C., 500° C., 600° C., 700° C.

However, since the process of the invention can be conducted in such a way that the substrate beneath the later glass layer is not exposed to a damaging temperature, it is now also possible to cover or to coat specifically those thermally sensitive substrates with a permanent glass layer in a simple manner.

The process of the invention also makes it possible to obtain relatively large-area glass coatings. There is no model at all for this in the prior art. This process outcome becomes possible especially because the process can also be commenced in a small area, i.e., for example, with a simple Bunsen burner flame, and the overall glass layer is formed only gradually. In this case, the sol-gel layer applied at first acts, inter alia, also as a thermal protective layer with respect to the substrate beneath.

According to the invention, what are thus enabled are especially those glass layers on substrates that have an extent of at least 2 cm².

In the development of the present invention, the inventors hit on, inter alia, GB 2 257 439 A, which describes the production of vitreous coatings, especially for teeth. This application describes the conversion of silica derivatives in the presence of a filler with a heat source acting locally. The heat source, which may also be laser radiation or a butane gas flame, then brings about the curing of the composition used.

The use of a heat source that acts at a point is essential to the process proposed in GB 2 257 439 A, since impairment of tissue structures around the teeth must be absolutely avoided in the curing of the coatings. One working example states, inter alia, that a glasslike structure can be obtained when the sol-gel coating is exposed to a butane gas flame (temperature 1000° C.). In the case of this process, however, it is obviously necessary to take note of the fact that, in the event of exposure for more than 3 to 6 seconds, cracking occurs immediately (cf. page 17 lines 13 to 16 of this application).

Thus, application of this process to larger-area substrates is thus not intended, nor does is it seem possible in view of the cracking observed. This is because what is envisaged by this application is that the flame is contacted at a speed of 6 to 8 cm/s over 2 to 4 seconds. Such a “narrow” process window cannot be implemented on a large scale, i.e. in the case of surfaces larger than 2 cm² or higher, for example above 10 cm². Even in the smaller areas, there is apparently considerable cracking, which can be explained in that the glass layers obtained are metastable. Glass coatings of the invention differ distinctly therefrom at least in that no cracking or detachment of the coating takes place on further thermal exposure (i.e. in the event of exceedance of the boundary conditions of a few seconds specified in GB 2 257 439 A).

Without being bound to this theoretical idea, the inventors are assuming that this difference can probably be explained in that a sufficient water atmosphere is constantly ensured in the process of the invention. With this knowledge, that apparently did not yet exist in the British application, it is possible, by means of simple tests for the particular heat source, to determine the adequate process conditions. According to the applicant's tests to date, however, the process of the invention succeeds regularly when it is assured that a temperature above 700° C., preferably 800° C. to 1100° C., is employed, and that (superheated) steam is present.

The great technical and economic advantage of the process of the invention is that no ovens or complex apparatuses are required for performance thereof. The surfaces to be sealed are not significantly heated in the course of treatment.

The spray application of the sol-gel lacquer and the subsequent flame exposure of the surfaces are effected largely independently of the shape and size of the components to be sealed. The spray application can be effected virtually at any site and even on fixedly installed parts. Repair to damaged surfaces is readily possible at any time, even without deinstalling the parts to be repaired.

The glass layers produced in accordance with the invention, according to the intensity of the coating, have thicknesses between 3 μm on smooth, nonabsorptive substrates and up to 15 μm on porous substrates. They are firmly anchored to the respective substrate material and do not become detached even under stress. They are homogeneous, pore-free and largely scratch-resistant. The scratch hardness in the case of a solid substrate is more than 1500 g.

### DETAILED DESCRIPTION OF THE INVENTION

The present invention relates to a process for producing a glass layer on a substrate, comprising the following steps:

a) applying a liquid sol to at least one surface of the substrate;

b) leaving the sol to react to form a gel; and

c) briefly treating the gel on the at least one surface outside an oven in the presence of steam at a temperature of at least 700° C.

Process steps a) and b) have already been elucidated above.

In the brief treatment of the gel on the at least one surface, it is important to apply a temperature that leads to formation of a glass layer consisting essentially of silicon oxide briefly to the gel surface. In particular, it should be ensured that the temperature is sufficiently high at first, at least 600° C. but preferably above 700° C. However, the thermal treatment should be brief in order, in particular, not to impair the substrate beneath the gel layer. Consequently, in the case of more sensitive substrates that may consist of wood or plastic, for example, one option is to repeat this operation several times.

Further embodiments of the invention are specified in the dependent claims.

More particularly, it was found that, for performance of the brief treatment of the sol on the at least one surface, it is possible to use a superheated steam. This steam should have a temperature above 700° C. This steam may be in the form of a mixture together with oxygen and possibly other gases. The duration of this treatment, based on the treated area, is in each case about 5 to 60 seconds, preferably 10 to 60 seconds. An intervening cooling phase may last for 60 seconds up to several minutes.

The invention also provides a composite material composed of a substrate and a glass layer, the glass layer being obtainable by the processes specified above.

Surfaces coated or sealed in accordance with the invention are
impermeable to water, gases and vapors
electrically insulating
stable to salt water and chemicals except for fluorides and strongly alkaline media
easy to clean
food-safe
resistant to UV rays and aging
noncombustible and withstand temperatures up to more than 700° C.

Glass layers of the invention for sealing of surfaces can, if required, be admixed with inorganic pigments in any desired color for production of colored surfaces, or with hard particles such as aluminum oxide or zirconium oxide in order to increase the wear resistance of the seal.

### EXAMPLES

### Example 1

A stainless steel sheet of 1.4301 material was wiped dry and a sol-gel lacquer was applied thereto in two runs by means of a spray gun. After the drying, the surface was subjected to flame treatment for a total duration of 40 seconds, in two runs each of 20 seconds separated by a cooling phase of 10 minutes.

After cooling, the surface had a continuous, pore-free glass layer. A scratch test at 1500 is g gave a scratch in the base material without damage to the glass layer.

### Example 2

An unglazed ceramic plate was coated with sol-gel lacquer in two runs by means of a spray gun and subjected to flame exposure in three steps for 20 seconds each time. After cooling, the surface had a smooth, continuous, glaze-like surface. The surface was watertight and easy to clean.

### Example 3

A concrete block with an untreated surface was cleaned by dry wiping and then coated with sol-gel lacquer in three runs by means of a spray gun. After drying, the surface was subjected to flame exposure in three runs for 20 seconds each time. After cooling, the surface had a hard, continuous, transparent and slightly shiny layer. The surface was watertight and impervious and easy to clean.

Further embodiments of the invention are defined as follows:

1. A process for producing a glass layer on a substrate, comprising the following steps:

a) applying a liquid sol to at least one surface of the substrate, where the sol comprises siloxanes of the formula Si(OR′)₄₋ₙR″ₙ with n=0, 1 or 2, where each OR′ is independently a hydroxyl, alkoxy and/or cycloalkoxy radical, and each R″, where present, is independently an alkyl and/or cycloalkyl radical;

b) leaving the sol to react to form a gel; and

c) briefly treating the gel on the at least one surface outside an oven in the presence of steam at a temperature of at least 700° C.

2. The process according to embodiment 1, wherein the sol further comprises one or more elements from the group consisting of Al, Ti, Cr, Mg, Ca and Zn.

3. The process according to either of the preceding embodiments, characterized in that, in step d), the at least one surface is treated with superheated steam.

4. The process according to any of the preceding embodiments, characterized in that, in step d), the treatment is effected by flame exposure to a gas flame.

5. The process according to embodiment 3, characterized in that, in step d), the superheated steam has at least a temperature of 700° C.

6. The process according to any of the preceding embodiments, characterized in that the treatment in step d) is effected in multiple successive steps each having a duration of 5 to 60 seconds.

7. The process according to any of the preceding embodiments, characterized in that the glass layer is colorless and transparent or contains color pigments or hard particles.

8. The process according to any of the preceding embodiments, characterized in that the glass layer has a thickness between 1 μm and 20 μm.

9. The process according to any of the preceding embodiments, characterized in that the glass layer has a large area (i.e. greater than 2-4 cm²)

10. A composite material composed of a substrate and a glass layer, wherein the glass layer is obtainable by any of the processes specified.

1-5. (canceled)

6. A process for producing a glass layer of thickness 1 μm to 20 μm and having an areal extent of greater than 2 cm² on a substrate of metal, ceramic, concrete, stone or wood, comprising:
a) applying a liquid sol to at least one surface of the substrate, where the sol comprises siloxanes of the formula Si(OR′)₄₋ₙR″ₙ with n=0, 1 or 2, where each OR′ is independently a hydroxyl, alkoxy and/or cycloalkoxy radical, and each R″, where present, is independently an alkyl and/or cycloalkyl radical;
b) leaving the sol to react to form a gel; and
c) treating the gel on the at least one surface outside an oven in the presence of steam at a temperature of at least 700° C. in one or more successive steps each having a duration of 5 to 60 seconds, so as to form a homogeneous, three-dimensional network of (SiO₂)ₙ.

7. The process as claimed in claim 6, wherein the sol further comprises one or more elements selected from the group consisting of Al, Ti, Cr, Mg, Ca and Zn.

8. The process as claimed in claim 6, wherein the treatment in step c) is effected in multiple successive steps each having a duration of 5 to 60 seconds.

9. A composite material comprising a substrate of metal, ceramic, concrete, stone or wood and a glass layer having an areal extent of greater than 2 cm², wherein the glass layer is prepared by the process of claim 6.
